(19) United States
(12) Patent Application Publication
(10) Pub. No.: US 2003/0196952 A1
(43) Pub. Date: Oct. 23, 2003

(54) Sand and particle separator for fluid pumping systems

(76) Inventor: Theodore A. Kampfen, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/421,558

(22) Filed: Apr. 22, 2003

Related U.S. Application Data
(60) Provisional application No. 60/374,787, filed on Apr. 23, 2002.

(51) Int. Cl. B01D 33/27; B01D 17/038

(52) U.S. Cl. 210/512.3; 166/105.1

(57) ABSTRACT

A sand and particle separator for fluids is configured to optimize the particulate removal and minimize the diameter of the system. An auger is located at the lower end of the separation chamber and is driven by a drive shaft. The drive shaft may extend through the separation chamber and to drive a pump located above the separation chamber. The separator may have other types of devices, such as shaped orifices, to create centrifugal force in the fluid. To increase the speed of the fluid within the separator, accelerators, such as a conical entrance to the chamber, may be added to the system to create a venturi effect on the fluid entering the separation chamber. A reflector may be attached around the drive shaft to reflect the cleaned fluid upward toward the pump.

### CROSS REFERENCE TO OTHER APPLICATIONS

This application claims priority of US Provisional Application No. 60/274,787, filed Apr. 23, 2002, which is hereby incorporated by reference in its entirety.

### FIELD OF INVENTION

The present invention relates generally to devices for separating particles from fluid. More particularly, it relates to a separator for use with downhole well pumping systems.

### BACKGROUND OF THE INVENTION

The presence of sand, silt, clay and other foreign particles in fluid, such as water pumped from deep wells, greatly accelerates pump wear. The pumps in wells are frequently located several hundred feet below the surface of the ground and in some instances even several thousand feet. Without a mechanism for separating the particulate matter from the fluid, the pump wears quickly and must be elevated periodically to the ground surface for replacement of worn parts. Pulling up a pump from such depths is both tedious and expensive. In order to avoid this, several systems have been designed to remove particulate material from the fluid prior to the fluid entering the pump.

Often, the designs of the prior art systems have a separation chamber located at the bottom of the device. Through various mechanisms, particles are removed from the fluid. The fluid is drawn up to the top of the chamber, then into and through a pump that forces the fluid to the surface. The configuration of these systems requires that the pump shroud be large enough that the fluid being pumped can pass around the perimeter of the motor. Furthermore, the well hole must be drilled large enough in diameter that the water can flow around both the pump shroud and the separation chamber so that the fluid can easily reach the inlet to the separation chamber. Since the cost of drilling is directly related to the diameter of the hole being drilled, any increase in system diameter greatly increases the installation cost of the system.

Due to the size of the separator, in most cases, the separator is assembled in place over the drilled hole. Assembly begins with the lowest end of the unit. Once the end of the unit is complete, the unit is lowered such that the next parts may be assembled on top of the last part built. This continues until the entire system is complete. While building the separator at the site and over the hole reduces the need for some of the large heavy machinery to transport, tilt up and place the separator, the assembly process is time consuming and difficult. The assemblers must be careful of their own safety, since they are working over a very deep hole. Getting into position to perform parts of the assembly can be awkward, leading to dropped tools and parts. Any significant tool or part dropped must be retrieved from a hole that may be up to several hundred feet deep or more.

Several prior art systems are discussed in the following patents, which are incorporated by reference: U.S. Pat. Nos. 3,289,608; 3,512,651; 3,568,837; 3,701,425; 3,947,364; 3,963,073; 4,027,481; 4,072,481; 4,120,795; 4,140,638; 4,147,630; 4,148,735; 4,305,825; and 4,555,333.

### SUMMARY OF THE INVENTION

The present invention takes the form of a sand and particle separator for fluid pumping systems. Water or fluid enters the separation chamber through inlet openings. The inlet openings may be ordinary or shaped openings through the outer shroud of the separator. Water entering the separator may also pass through an optional fixed spin plate. The shaped inlet openings and spin plate use shaped orifices to direct fluid to flow in a spiral, thereby creating centrifugal force which causes any particulate material to move to the outermost area of the separation chamber. The drive shaft of the motor extends through the separation chamber and may be used to drive a plate or fins to create or accelerate the circular motion in the fluid within the separation chamber. The drive shaft may also be used to drive a pump, which is located above the separation chamber and pumps the fluid upward. Located at the base of the separation chamber is an auger or screw, which draws the particulate material from the separation chamber into a particle outlet chamber. The particles may then be expelled or allowed to flow out of the separator through particle discharge openings.

To increase the speed of the fluid within the separator, accelerators, such as a conical entrance to the chamber, may be added to the system to create a venturi effect on the fluid entering the separation chamber. A reflector plate may be located around the drive shaft to reflect the cleaned fluid upward toward the pump.

Other embodiments use a similar auger system for removal of particulate material in turbine and centrifugal pump systems.

Other objects and advantages of the invention will no doubt occur to those skilled in the art upon reading and understanding the following detailed description along with the accompanying drawings.

### BRIEF DESCRIPTION OF THE DRAWINGS

FIG. 1 shows a prior art sand separation system.

FIG. 2 shows a cross section of a basic embodiment of the separation system of the present invention.

FIG. 3 shows a cross section of a second embodiment of the separation system having a spin plate.

FIG. 4 shows a cross section of a third embodiment of the separation system having a tapered fluid entry.

FIG. 5 shows a cross section of a fourth embodiment of the separation system having an integral multi-stage pump.

FIG. 6 shows a cross section of an embodiment using the centrifugal force of the fluid in the system to act as a motor.

FIGS. 7 and 8 are top and cross-sectional views of one version of the fluid inlet openings.

### DETAILED DESCRIPTION OF THE INVENTION

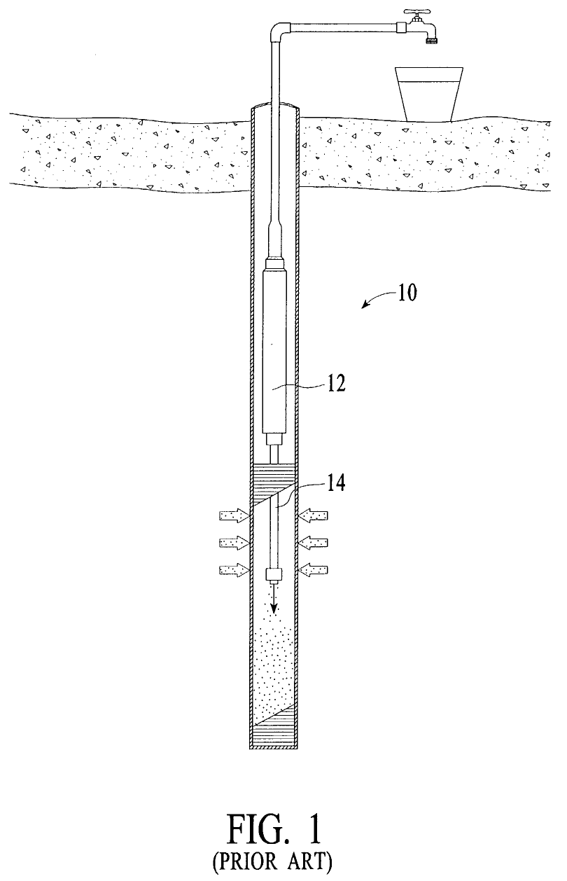

FIG. 1 shows a prior art sand separation system 10. In this prior art system 10, the pump occupies the upper portion of the pump shroud 12 and the pump motor is located below the pump within the shroud 12. The separator unit 14 is located below the pump shroud 12. In this system, the fluid being draw up by the pump must pass around the periphery of the pump motor. Based on this configuration, the diameter of the hole must be large enough for the motor diameter, a flow channel for the cleaned water to pass around the outside of the motor and within the pump shroud 12, as well as have clearance around the pump shroud 12.

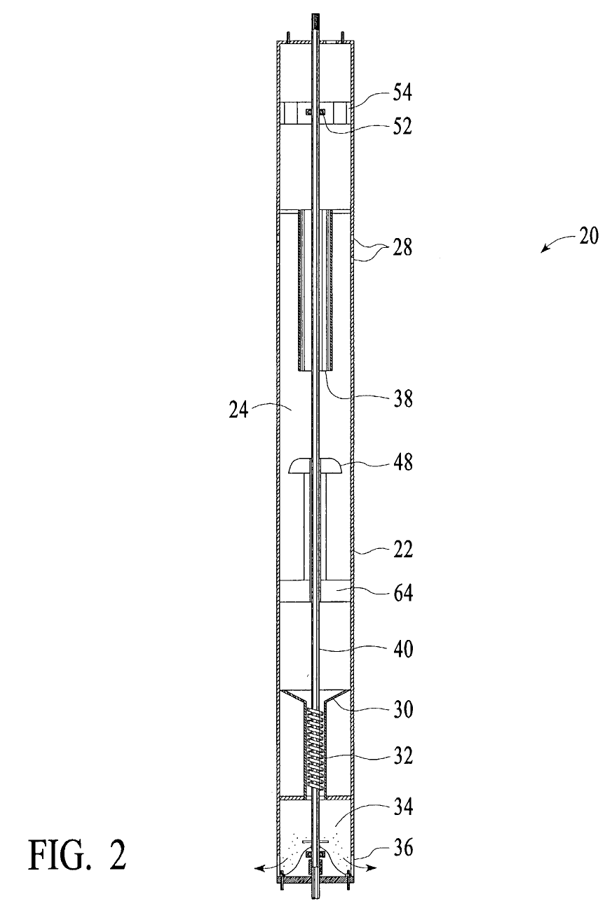

FIG. 2 shows a cross section of a basic embodiment of the separation system 20 of the present invention taking the form of a single shroud 22 for the separation chamber 24 and pumping system 26. Fluid enters the separation chamber 24 through one or more inlet openings 28. The fluid begins to move in a circular path down the separation chamber 24. The rotation of the water tends to force any particulate material to the outside edge of the separation chamber 24. The particulate material continues to move down to a collection cone 30 in the base of the separation chamber 24. At the base of the cone 30 is a screw or auger 32, which draws the particulate material out of the separation chamber 24 and into the particle outlet chamber 34. The screw 32 must provide sufficient pull to draw down the particulate material against the upward forces created by the pump 26 and any frictional forces caused by the particulate material in the fluid. The particle outlet chamber 34 has one or more discharge openings 36 in the base to allow the material to exit the particle outlet chamber 34.

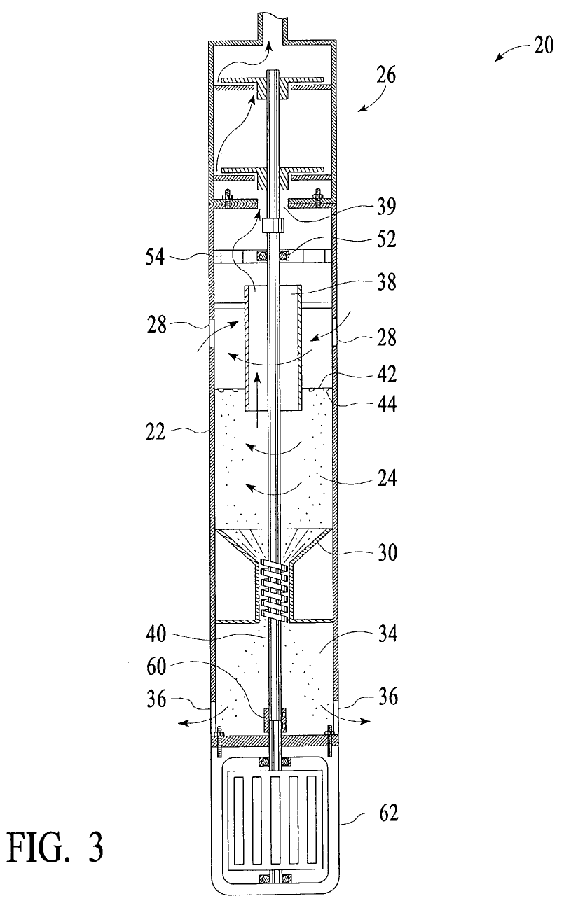

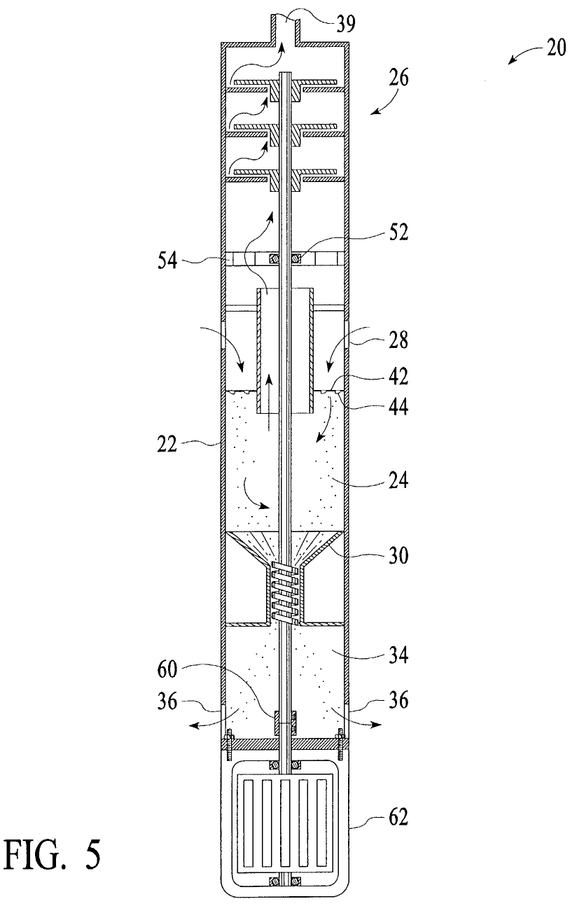

The fluid remaining in the separation chamber 24 is now free of most of the particulate material. The fluid is drawn upward in the center of the separation chamber 24 and through the clear water passage 38 to the fluid outlet 39 by the pump 26. Located at the base of the shroud 22 is a motor 62, seen in FIGS. 3-5, with a drive shaft 40 extending upward. The drive shaft 40 may extend part way or through the entire length of the shroud 22. The drive shaft 40 may be used to drive many of the features of the separator system 20. For example, the auger or screw 32 is formed onto the perimeter of the drive shaft 40 or is attached thereto. The drive shaft 40 may also be used to drive the pump 26. Depending on the depth of the well and the amount and speed the fluid needs to exit the well, a single pump, a multi-stage pump, as seen in FIG. 5, or a series of serial pumps may be used to draw the water out of the well.

FIGS. 3-8 show alternate variations of the separation system 20. In addition to the features shown in FIG. 2, some of these embodiments have additional optional features to improve the performance of the separation process. To increase the rotational velocity of the fluid in the separation chamber 24, the system 20 may have one or more of the features discussed below.

A spin plate 42, seen in FIG. 3, may be used to direct the fluid entering the separation chamber 24 to flow in the desired circular path.

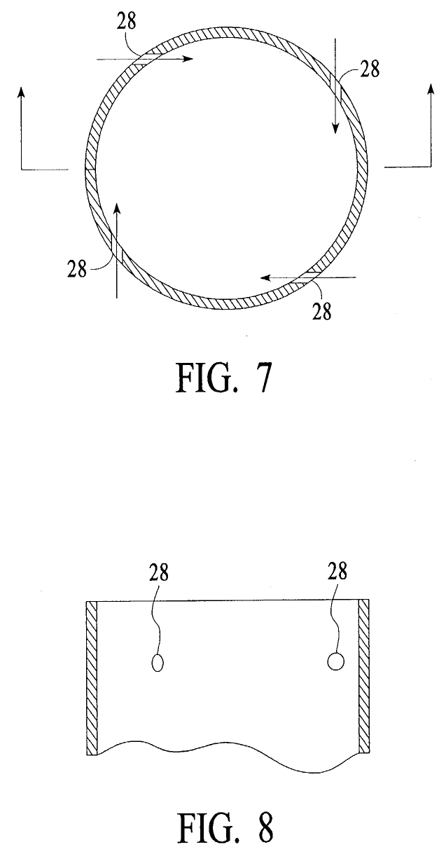

Shaped orifices 44 may be located in the wall of the shroud 22, seen in detail in FIGS. 7 and 8, thereby directing the fluid as the fluid enters the shroud 22 and separation chamber 24 or the shaped orifices 44 may be located only on the spin plate 42 located generally horizontally within the shroud 22 and forming the majority of the top of the separation chamber 24. A simple form of the shaped orifices 44 may be formed by creating a hole in the sidewall of the separation chamber 24 that is at an angled, as seen in FIG. 7. In this configuration, the fluid entering the system 22 is already directed to rotate about the separation chamber 24. This effect may also be created by and insert or other formation of shaped orifice 44.

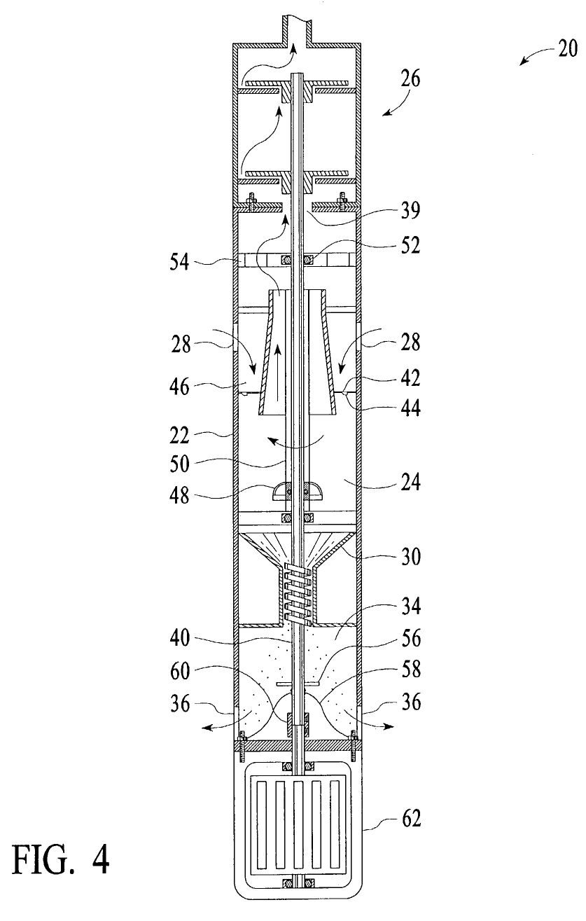

The system 20 may also use an optional alternate configuration of a tapered fluid entry. This may take the form of an angled section at the top of the separation chamber 24 or it may be a tapered chamber 46 above a spin plate 42, seen in FIG. 4. The taper creates a venturi effect, thereby increasing the rotational velocity of the water as it exits the entry area and enters the main portion of the separation chamber 24. The taper may be a shorter section within the entry area or it may extend down the full length of the entry area. If desired, fins or other mechanical impellers may be attached to the drive shaft 40, thereby forcing the fluid into a rotational motion.

In FIG. 4, an optional reflector plate 48 is placed near the bottom of the separation chamber 24 to reflect the cleaned fluid upward toward the fluid outlet 39. The reflector 48 may be stabilized by attaching depending legs extending from the reflector 48 directly to the wall of the chamber 24 or by a separate support with openings, such as a spider 64, attached to the wall of the chamber 24. If desired a bearing 66 may be connected to the reflector 48 and/or spider 64, as seen in FIG. 2. In the version shown in FIG. 4, a single bearing 50 extends through the clear water passage 38 and down to the reflector 48.

The separation system 20 may include active dumping through the discharge openings 36 of the particulate material drawn into the particle outlet chamber 34. The dumping may be created by a venturi effect, fluid movement or by the pressure of the material being drawn into the particle outlet chamber 34 by the auger 32.

To improve the stability of the drive shaft 40, additional bearings may be added. For example, a second spider 54 supported bearing 52 may be placed above the inlet openings 28, as seen in FIGS. 3-5. Another option is to use a long tubular bearing or two or more short bearings within a tube 50 around the drive shaft 40 and extending through the clear water passage 38.

FIG. 4 also shows several optional features at the base of the particle outlet chamber 34: a slinger 56, a sand shield 58 and additional bearings 60. The slinger 56 is a disk attached to the drive shaft 40. As the drive shaft 40 and slinger 56 rotate, any particulate material dropping onto the slinger 56 is pushed outward towards the outer wall of the particle outlet chamber 34 and the discharge openings 36. The sand shield 58 is a dome or inverted cone located at the base of the particle outlet chamber 34. The sand shield 58 urges the particulate material away from the drive shaft 40 and bearings 60 and towards the discharge openings 36. The additional bearings 60 may be used to provide additional support for the drive shaft 40. The other embodiments disclosed herein may include any one or more of these additional features.

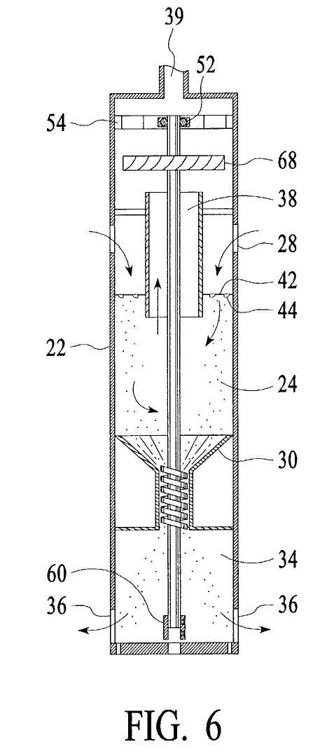

FIG. 6 shows a separation system 20 using the rotation of the fluid in the system to drive the auger 32. In this system 20, the fluid acts as a motor by powering fins 68 on the drive shaft 40, which in turn drives the auger 32.

In some embodiments of the invention, the system 20 may be formed of two, three or more of modular parts, which could quickly connect together. A few bolts around the perimeter of the shroud 22 could be used to perform the final assembly. For example, the pump 26, sand separation chamber 24 and motor 62 could all be separate units that bolt together, as seen in FIGS. 3 and 4. Alternately, the pump 26 and sand separation chamber 24 could be a single unit, which attaches to a motor unit 62, as seen in FIG. 5.

The system may also be used with a turbine pump, which is driven from the surface. In this case, the drive shaft extends from a motor, located at the surface, down through the pump shaft and into the sand separation system.

The system could be used on existing pump systems by retrofitting the motor and auger system onto any pump with an open bottom end or by creating an open bottom or openings in the bottom to add the auger and motor. This would convert a pump-only system to a sand-separating pump system.

Many features have been listed with particular configurations, options, and embodiments. Any one or more of the features described may be added to or combined with any of the other embodiments or other standard devices to create alternate combinations and embodiments.

Although the examples given include many specificities, they are intended as illustrative of only a few possible embodiments of the invention. Other embodiments and modifications will, no doubt, occur to those skilled in the art. For example, several types of motors have been described for driving the drive shaft, if preferred, other motors or motors substitutes may be used. Thus, the examples given should only be interpreted as illustrations of some of the preferred embodiments of the invention, and the full scope of the invention should be determined by the appended claims and their legal equivalents.

I claim:

1. A particle fluid separation system, comprising:
a housing shroud having a separation chamber,
a fluid inlet leading into said separation chamber,
a fluid outlet leading out of said separation chamber,
a drive shaft,
a motor means for driving said drive shaft,
and a screw driven by said drive shaft and located in a lower portion of said separation chamber, said screw designed and configured to draw particulate material from said separation chamber.

2. The particle fluid separation system of claim 1, wherein said motor means is an electric motor.

3. The particle fluid separation system of claim 1, wherein said motor means is created by fins attached to said drive shaft being driven by motion of fluid within said separation chamber.

4. The particle fluid separation system of claim 1, further comprising means for imparting a rotational motion to fluid entering said separation chamber.

5. The particle fluid separation system of claim 4, wherein said imparting means is at least one shaped orifice forming said fluid inlet.

6. The particle fluid separation system of claim 5, wherein said shaped orifice is on a spin plate forming at least a portion of a top of said separation chamber.

7. The particle fluid separation system of claim 5, wherein said shaped orifice is through a wall of said housing shroud.

8. The particle fluid separation system of claim 4, wherein said imparting means includes a narrowing passage in a fluid inlet, thereby creating a venturi effect.

9. The particle fluid separation system of claim 1, further comprising a pump located above said separation chamber.

10. The particle fluid separation system of claim 9, wherein said pump is located at ground level.

11. The particle fluid separation system of claim 9, wherein said pump is located adjacent a top end of said separation chamber.

12. The particle fluid separation system of claim 1, further comprising a reflector located above said screw.

13. The particle fluid separation system of claim 12, further comprising a spider support attached to said housing shroud, said reflector being attached to said spider support.

14. The particle fluid separation system of claim 1, further comprising a funnel member leading to said screw.

15. The particle fluid separation system of claim 1, further comprising a spider support holding a bearing located around said drive shaft above said fluid inlet.

16. The particle fluid separation system of claim 1, further comprising a tube around said drive shaft and at least partially within said separation chamber.

17. The particle fluid separation system of claim 16, wherein said tube has a long tubular bearing attached thereto.

18. The particle fluid separation system of claim 16, wherein said tube has at least two bearings attached thereto.

19. The particle fluid separation system of claim 1, further comprising particle outlet chamber located below said screw.

20. The particle fluid separation system of claim 19, further comprising a slinger located within said particle outlet chamber and attached to said drive shaft.

21. The particle fluid separation system of claim 19, further comprising a sand shield located within said particle outlet chamber.

22. The particle fluid separation system of claim 1, wherein said screw is an auger.

23. A particle fluid separation system, comprising:
a housing shroud having a separation chamber,
a fluid inlet leading into said separation chamber,
a fluid outlet leading out of said separation chamber,
a motor,
a drive shaft extending from said motor,
and a screw driven by said drive shaft and located in a lower portion of said separation chamber, said screw designed and configured to draw particulate material from said separation chamber.

24. The particle fluid separation system of claim 23, further comprising means for imparting a rotational motion to fluid entering said separation chamber.

25. The particle fluid separation system of claim 25, wherein said imparting means is at least one shaped orifice forming said fluid inlet.

26. The particle fluid separation system of claim 23, further comprising a pump located above said separation chamber.

27. The particle fluid separation system of claim 26, wherein said pump is located adjacent a top end of said separation chamber.

28. The particle fluid separation system of claim 23, further comprising a reflector located above said screw.

29. The particle fluid separation system of claim 23, further comprising a funnel member leading to said screw.

30. The particle fluid separation system of claim 23, further comprising a spider support holding a bearing located around said drive shaft above said fluid inlet.

31. The particle fluid separation system of claim 23, further comprising a tube around said drive shaft and within said separation chamber.

32. The particle fluid separation system of claim 31, wherein said tube has a long tubular bearing attached thereto.

33. The particle fluid separation system of claim 31, wherein said tube has at least two bearings attached thereto.

34. The particle fluid separation system of claim 23, wherein said screw is an auger.

35. A particle fluid separation system, comprising:
a housing having a fluid inlet, a particle outlet, a fluid outlet, a top portion, a middle portion and a bottom portion,
a motor located in said bottom portion,
a drive shaft connected to said motor and extend upward through said housing,
a pump located above said fluid inlet,
and means for imparting a rotational motion to fluid entering said housing through said fluid inlet.
